(19) United States
(12) Patent Application Publication
(10) Pub. No.: US 2007/0211998 A1
(43) Pub. Date: Sep. 13, 2007

(54) Inner Housing For A Fibre-Optic Plug Connector

(76) Inventors: Marion Muhlegg, Benken (CH); Claudio Streiff, Uster (CH)

Correspondence Address: STURM & FIX LLP, 206 SIXTH AVENUE, SUITE 1213, DES MOINES, IA, 50309-4076, US

(21) Appl. No.: 11/575,894

(22) PCT Filed: Aug. 30, 2005
(86) PCT No.: PCT/CH05/00508

§ 371 Date: Mar. 23, 2007

(30) Foreign Application Priority Data
Sep. 24, 2004 (CH) 1564/04

(51) Int. Cl. G02B 6/38

(52) U.S. Cl. 385/62

(57) ABSTRACT

An interior housing (1) for a connector for the insertion of a ferrule (6) of a optical fibre cable (5) exhibits at least one lateral slot (4), as well as a notch-shaped recess (8) in the rear wall (7) of this interior housing (1). The slot (4) and recess (8) are formed and dimensioned so that a ferrule (6) of a ready-made optical fibre cable (5) can be inserted laterally into the interior housing (1). The interior housing is provided with at least one spring element (9), which serves for the axial positioning of the ferrule (6). On one side, this spring element presses against the ferrule (6) and on the other side against the rear wall (7) of the interior housing (1).

The present invention involves an interior housing for a connector, in particular an SC-type connector, to allow for the reception of an optical fibre cable ferrule, particularly POF ferrules, in accordance with the preamble of Claim 1.

Such interior housings are used in optical fibre connectors, as can be seen in WO99/42877, for example. This text describes an optical fibre connector, in particular a standardised SC-type connector, with an external housing (hereafter also referred to as the connector housing) and an interior housing (hereafter also referred to as ferrule housing or ferrule container). An optical fibre ferrule is fastened inside the interior housing. The external housing can be fitted over the interior housing and makes it possible to disconnect the interior housing from a connector or coupler in a push-pull manner.

When coupling optical fibres, it is extremely important that the front surfaces of the optical conductors are in full contact with one another. Therefore, in U.S. Pat. No. 5,287,425 it is suggested that the ferrule be provided with elastic support within the ferrule housing with the aid of a spiral spring. This makes it possible for the front surfaces of the optical conductor to be pressed up against one other when the coupling has spring force (tension).

Today, the manufacture and in particular the sizing of optical cables are always performed by the manufacturer. The manufacturer has the necessary (expensive) devices to cut the individual optical cables to length and to remove their isolation layer in order to introduce the ends of the optical fibres into a ferrule and fasten them inside in order to polish the front surface of the respective optical fibres, as well as to situate the individual ferrules in an interior housing. However, for reasons of simplicity, there is an increasing desire to be able to perform these operations on-site during assembly. Unfortunately, however, all prior art type optical fibre connectors prove unsuitable for simple field manufacturing.

The purpose of the present invention is therefore to create an optical fibre connector that can be field-manufactured and connected on-site with an optical cable without highly sophisticated and expensive special tools by an unskilled person.

The invention solves this problem by means of interior housing with the characteristics of Claim 1 and in particular by means of a connector interior housing allowing for the insertion of a ready-made optical fibre ferrule, with the interior housing exhibiting at least one slot on the side. This lateral slot is formed and dimensioned in such a manner is that a ready-made optical fibre ferrule can be inserted laterally. In the preferred design for the invention, the interior housing covers a rear wall, which is provided with a notch-shaped recess so that the lateral slot and this notch-shaped recess form a common housing opening for the lateral insertion of a ready-made optical fibre cable ferrule. The interior housing, according to the invention, is preferably provided with at least one spring element for the axial positioning of the ferrule. This spring element bears against the interior housing, preferably at the rear wall, and presses the ferrule against a stop area. The use of a pair of leaf springs as the spring element proves particularly favourable, because this can already be pre-mounted at the factory and also because their curvature ensures that the inserted ferrule is safeguarded within the interior housing. In a special further development of the present invention, the interior housing exhibits, at least on the lateral slot facing the side of the interior housing, at least one opening for the non-destructive removal of the ferrule attached to the interior housing. A screwdriver or another suitable tool can be introduced via this opening in order to press the ferrule against the spring force of the spring elements from the interior housing.

The interior housing, according to the invention, can be introduced as a module part in many different kinds of connectors and can also be used for connector housing in accordance with EP Application No. 04003701.2.

Below, the invention is described on the basis of a design example and using more detailed figures. These show:

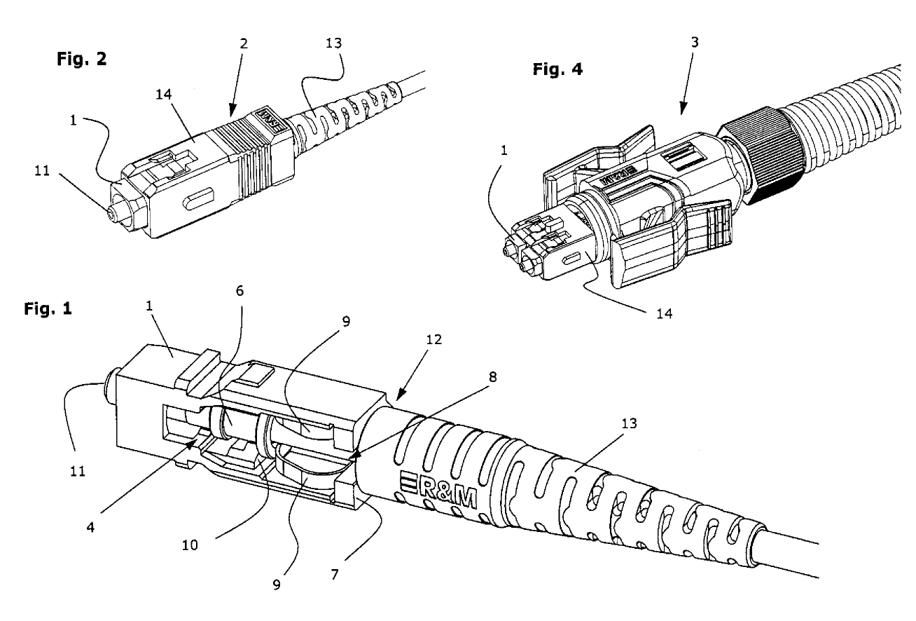

FIG. 1: A spatial view of the interior housing, according to the invention, in the installed state;

FIG. 2: A spatial representation of an SC-type connector with an interior housing, according to the invention;

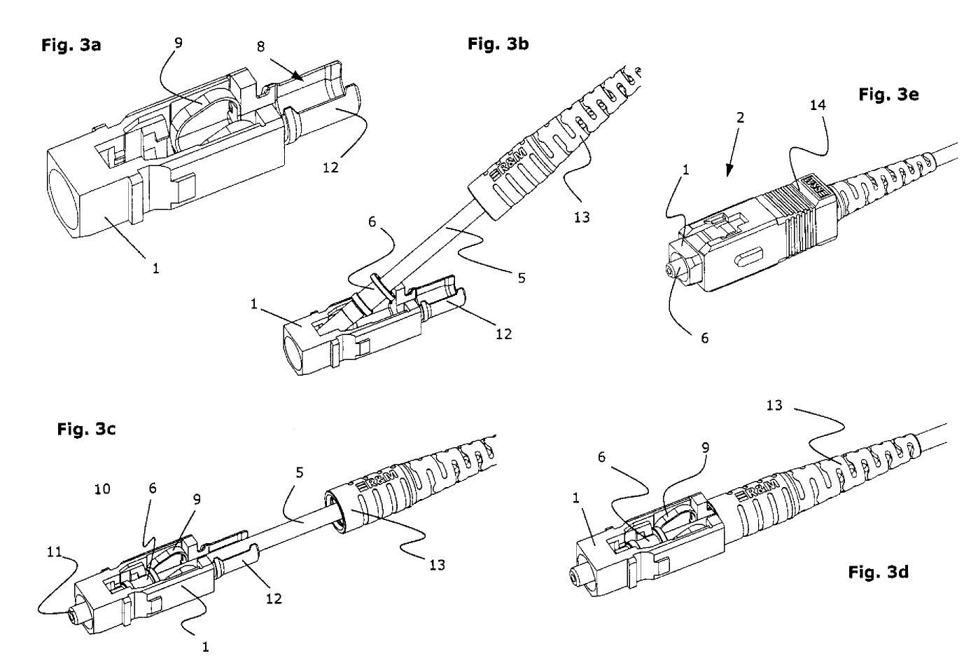

FIG. 3a-e: The assembly steps for on-site assembly;

FIG. 4: The use of the interior housing, according to the invention, in an SC-RJ connector.

FIG. 1 illustrates the structure and the function method of the interior housing according to invention 1 for a connector 2, 3 clear. This interior housing 1 exhibits a lateral slot 4, which allows for the lateral insertion of a ready-made optical fibre cable 5 with its ferrule 6 into the housing. The illustrated design form of the interior housing 1 exhibits a rear wall 7 with a notch-shaped recess 8. This rear wall makes it possible to insert spring elements, esp. leaf springs 9, which press the ferrule 6 against a stop surface. This makes it possible to press the face 11 of the optical fibre at the coupling against the face of a corresponding optical fibre. In order to protect an optical fibre cable 5 installed in such a manner, the interior housing 1, according to the invention, exhibits a flange 12 rising up away from the rear wall 7, and a standard type of kink protection 13 can be pushed over this. Additionally, this interior housing 1 exhibits, on at least one of its sides, preferably on the sides 4 opposite the lateral slots, at least one opening (not shown) for the non-destructive dismounting of the ferrule 6 fastened in the interior housing 1. In particular, this opening should make it possible, by using a screwdriver or a similar tool, to remove the ferrule 6 with the optical fibre cable 5 from the inner housing 1. In place of the leaf spring 9, a spiral spring or another flexible element can be used as a spring element 9. The interior housing thus equipped 1 can be slid in the standard manner into an external housing 14, in order to form a push-pull connector 2, as shown in FIG. 2. FIG. 2 shows the outer contours of a SC-type connector, already in use today, with a POF ferrule and standardised connector dimensions.

FIGS. 3a-3e show the assembly of a connector 2 with the help of the interior housing according to invention 1. A kink protector 13 is pushed onto an optical fibre cable 5 that has been cut to length on-site and the end of this cable 5 is stripped. The released optical fibre can now be introduced into a ferrule 6. For the attachment of the ferrule 6 to the optical fibre cable 5, a screw-on ferrule 6 such as the one from EP-A-1457797 is particularly suitable. As is evident from FIG. 3b, such types of ready-made optical fibre cables 5 are inserted, along with their ferrule 6, laterally into an interior housing 1 according to the invention. From FIG. 3c, it is evident how the inserted ferrule 6 presses, with the help of the leaf springs 9, against a stop surface 10. This spring element permits an axial movement between the interior housing 1 and the ferrule 6 lying within. In order to better protect the optical fibre cable 5, a kink protector 13 is pushed over a flange 12. FIG. 3d shows the interior housing 1 in the installed condition in accordance with the invention, that is: with ready-made optical fibre cable 5 and with the kink protector 13 pushed in. Interior housing 1 equipped in such a manner can now, as shown by FIG. 3e, be inserted in a final step into a standardised external housing 2, and in particular into an SC-RJ-DUPLEX connector (see FIG. 4).

The interior housing 1 according to the invention is suitable for setting up an SC-type connector 2 (see. FIG. 2) for use in the home, as well as for the production of an industrial-scale SC-RJ connector (see FIG. 4). The present construction makes it possible to use different types of optical fibre cables 5, especially single or multi-mode glass or plastic optical fibres (POF) can be used, with gradation or gradient indices.

The advantages of the present invention are directly evident to the specialist and can be seen in particular in its ability to be manufactured in the field, the modularity of the individual construction units and in its non-destructive disassembly. In particular, no special tools or aids are necessary for assembly and disassembly, which allows for a simple and fast job, even by laymen. Disassembly can be carried out without destruction, that is: the individual parts are reusable. Since the inserted ferrule with the coupling in the centre piece is aligned with the coupling piece, complex technical measures for centring the optical conductor are not necessary. It is particularly beneficial to use a pair of leaf springs as the spring element, since these can already be pre-mounted at the factory, and so the construction units produced in the “field” can be limited to a necessary minimum.

It is to be pointed out that the detailed design example shown above can be arranged and dimensioned differently (in particular in accordance with the dimensions of the SC, ST, or SMA) without having to take into account any technical considerations about lateral mounting capabilities.

1. Interior housing of a connector, in particular an SC-type connector (2), for the admission of a ferrule (6) of a optical fibre cable (5), in particular a POF ferrule, whereby the interior housing (1) exhibits at least one lateral slot (4), wherein this lateral slot (4) is formed and dimensioned such that a ferrule (6) of a ready-made optical fibre cable (5) can be inserted laterally.

2. Interior housing according to claim 1, characterised in that this housing comprises a rear wall (7), which is provided with a notch-shaped recess (8), so that the lateral slot (4) and this notch-shaped recess (8) form a common housing opening for the lateral insertion of a ferrule (6) of a ready-made optical fibre cable (5).

3. Interior housing according to claim 1 or 2, characterised in that this housing is provided with at least one spring element (9) for the axial positioning of a ferrule (6) of a ready-made optical fibre cable (5).

4. Interior housing according to claim 3, characterised in that the spring element (9) pushes against the interior housing (1).

5. Interior housing according to claim 4, characterised in that this spring element (9) is borne by the rear wall (7) of the interior housing (1).

6. Interior housing according to claims 3 to 5, characterised in that the spring element (9) is designed as a leaf spring.

7. Interior housing according to one of the preceding claims, characterised in that on the side of the interior housing (1) opposite the lateral slot (4), there is at least one opening for the non-destructive withdrawal of a ferrule (6) of a ready-made optical fibre cable (5) attached inside the interior housing (1).

8. Connector with an interior housing according to claim 1.
